(19) United States
(12) Patent Application Publication
(10) Pub. No.: US 2014/0214510 A1
(43) Pub. Date: Jul. 31, 2014

(54) SOCIAL REWARDS

(71) Applicants: SRIRAM KARRI, Hyderabad (IN); PUJA YAGNIK, Jersey City, NJ (US); RAVINDRA RATHI, Jersey City, NJ (US); SATYA ROHIT LINGINENI, Hyderabad (IN); AMITH LULLA, Secunderabad (IN)

(72) Inventors: SRIRAM KARRI, Hyderabad (IN); PUJA YAGNIK, Jersey City, NJ (US); RAVINDRA RATHI, Jersey City, NJ (US); SATYA ROHIT LINGINENI, Hyderabad (IN); AMITH LULLA, Secunderabad (IN)

(21) Appl. No.: 13/752,417

(22) Filed: Jan. 29, 2013

(51) Int. Cl. G06Q 30/02; G06Q 50/22

(52) U.S. Cl. CPC G06Q 30/0217; G06Q 50/22
USPC 705/14.19

(57) ABSTRACT

In accordance with an example embodiment, a method and system for rewarding socially is provided. The method includes tracking one or more activities associated with a data present in electronic media content. The method further determines a social influence value of the data based on the one or more activities. Thereafter, the method electronically rewards one or more users associated with the data based on the social influence value.

### TECHNICAL FIELD

The present technology generally relates to social media network environment, and more particularly, relates to rewarding users of the social media network based on social influence of their online activities.

### BACKGROUND

Presently, social media plays a vital role in collaborating information and has become an essential source of information sharing. Examples of social media include, but are not limited to, social networking websites, multimedia content communities, online blogs and micro-blogs. The social media allows users to create, share, exchange information and collaborate with one another. For example, a user may express his/her views or share opinion regarding a product or a service, by posting a comment on a social networking website. Thereafter, other users in the user's social network may respond or reply to the comment. The other users may even ‘like’ or ‘dislike’ the comment and/or share the comment with other users in their respective social networks and accordingly create a social activity chain for the comment. The social activity chain is generally stored in a server of the social network website for a predefined timeframe. The social activity chain during the pre-defined timeframe can be analyzed and utilized to extract different information regarding the product or the service. For example, feedbacks included in the social activity chain can be used to improve the product or the service. Similarly, the social activity chain can also be used to identify the public perception and brand worth of the product or service.

### SUMMARY OF SOME EMBODIMENTS

This summary is provided to introduce a selection of concepts in a simplified form that are further described below in the detailed description. This summary is not intended to identify key or essential features of the claimed subject matter, nor is it intended to be used as an aid in determining the scope of the claimed subject matter.

In one embodiment, computer implemented method comprises tracking one or more activities associated with a data present in electronic media content. The method further comprises determining a social influence value of the data based on the one or more activities. Further, the method comprises electronically rewarding one or more users associated with the data based on the social influence value.

In another embodiment, a computer system is provided. The computer system comprises a memory to store instructions. The computer system further comprises one or more processors which include program instructions to track one or more activities associated with a data present in electronic media content and determine a social influence value of the data based on the one or more activities. The one or more processors further include program instructions to reward one or more users associated with the data based on the social influence value.

In another embodiment, a non-transitory, computer-readable storage medium storing computer-executable program instructions to implement tracking of one or more activities associated with a data present in electronic media content. The computer-executable program instructions further implements determining a social influence value of the data based on the one or more activities. The computer-executable program instructions further implements rewarding one or more users associated with the data based on the social influence value.

Other aspects and example embodiments are provided in the drawings and the detailed description that follows.

### BRIEF DESCRIPTION OF THE FIGURES

For a more complete understanding of example embodiments of the present technology, reference is now made to the following descriptions taken in connection with the accompanying drawings in which:

FIG. 1 illustrates an example of an environment, where various embodiments may be implemented;

FIG. 2 illustrates a schematic flow diagram of a system for social rewarding, in accordance with an exemplary embodiment;

FIG. 3 illustrates a Graphical User (GUI) interface of a social networking website, in accordance with an exemplary embodiment;

FIG. 4 illustrates a graphical representation of social influence trail, in accordance with an exemplary embodiment;

FIG. 5 illustrates different phases for calculating social influence value, in accordance with an exemplary embodiment;

FIG. 6 illustrates an example of calculating social influence values, in accordance with an exemplary embodiment;

FIG. 7 illustrates various module included in a processor, in accordance with an exemplary embodiment;

FIG. 8 illustrates a schematic view of a computer system, in accordance with an exemplary embodiment;

FIG. 9 is a flowchart depicting an exemplary method of the social rewarding, in accordance with an exemplary embodiment;

FIGS. 10A and 10B are flowcharts depicting an exemplary method of the social rewarding, in accordance with another exemplary embodiment;

FIG. 11 illustrates a schematic representation of social rewarding, in accordance with an exemplary embodiment;

FIG. 12 illustrates a schematic representation of social rewarding, in accordance with another exemplary embodiment;

FIGS. 13A and 13B illustrate a schematic representation of social rewarding, in accordance with still another exemplary embodiment; and

FIGS. 14A and 14B illustrate a schematic representation of social rewarding, in accordance with yet another exemplary embodiment.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to ‘one embodiment’ or ‘an embodiment’ means that a particular feature, structure, or characteristic described in connection with the embodiment is included in at least one embodiment of the present technology. The appearance of the phrase ‘in one embodiment’ in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

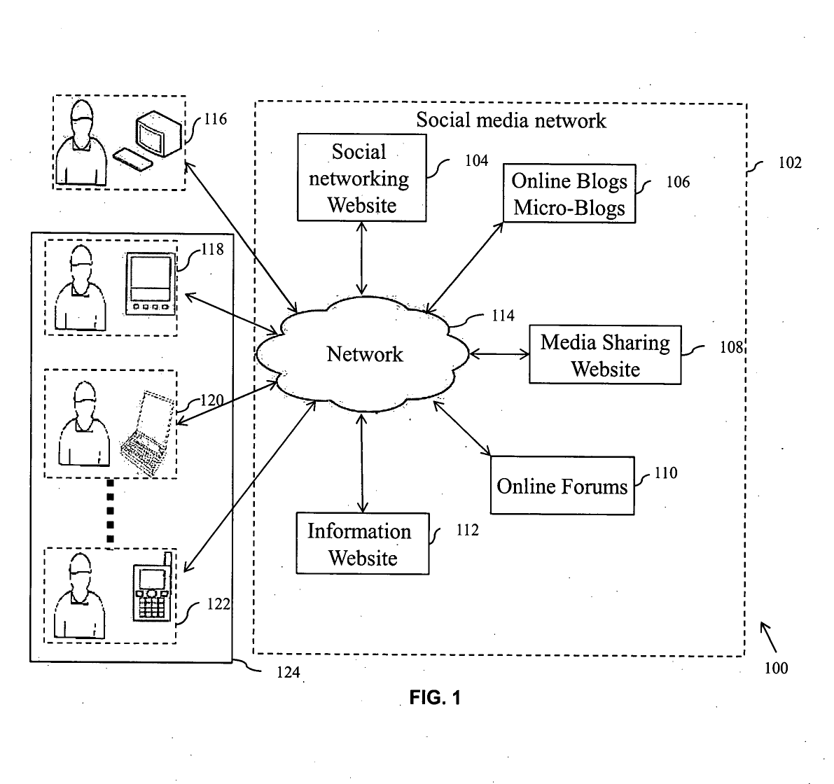

FIG. 1 illustrates an example of an environment 100, where various embodiments of the present technology may be implemented. The environment 100 is shown to include a social media network 102 and a plurality of users. The social media network 102 includes elements such as social networking website 104, online blogs and microblogs 106, media sharing websites 108, online forums 110 and information websites 112. Each of these elements is communicatively coupled to one another through a network 114. Examples of network 114 includes, but are not limited to, the Internet, a Wireless Fidelity (Wi-Fi), a Wireless/Wire lined Local Area Network (LAN), and Wide Area Network (WAN).

The plurality of users, for example user 116, user 118, user 120, and user 122, can access various elements within the social media network 102 through one or more electronic devices associated with each user and the network 114. Examples of the one or more electronic devices may include, but are not limited to, mobile, laptop, desktop, tablet, personal digital assistance device, palmtop, and the like. The social media network 102 allows users to collaborate and socially connect with each other. For example, the user 116 socially connects and collaborates with other users 118, 120 and 122 using the social media network 102. The users 118, 120, and 122 can be colleagues, friends, relatives, friends or any social network friend, and the like. In some cases, the users 118, 120 and 122 may not be socially linked with the user 116. The users 118, 120 and 122 can be defined as a group of users 124. The group of users 124 are also referred as social contacts of the user 116. It should be understood by a person ordinarily skilled in the art that description of the group of users 124 is exemplary and can have any number of users, communicatively and socially linked with the first user 116.

The social media network 102 also allows the user 116 to post and share comments, web content, Uniform Resource Locator (URL), provide feedback, and like/dislike any comments. For example, the user 116 can post comment regarding a product in a comment section of his/her profile that is created on the social networking website 104. The comment posted by the user 116 can then trigger an impact on other users in the user's social contact, for example, on the group of users 124. The group of users 124 can then react to the posted comment by way of expressing appreciation for the comments by posting a ‘Reply’, ‘Answer’, ‘Response’, or ‘Feedback’ for the comment.

The group of users 124 may even share the comment with their own individual social networks contacts through options like ‘Share’, ‘Tell’, or ‘Spread’ in the social networking website 104. The reactions of the users create a trail of activities on the comment posted by the user 116. The reactions of users and the trail of activities circuitously create awareness and cognizance about the product on which the comment was posted by the user 116. Thus, promoters, agents, sellers or manufacturer of the product can reward the user 116 for creating awareness about the product. The method of rewarding the user is further explained in detailed in reference with subsequent figures.

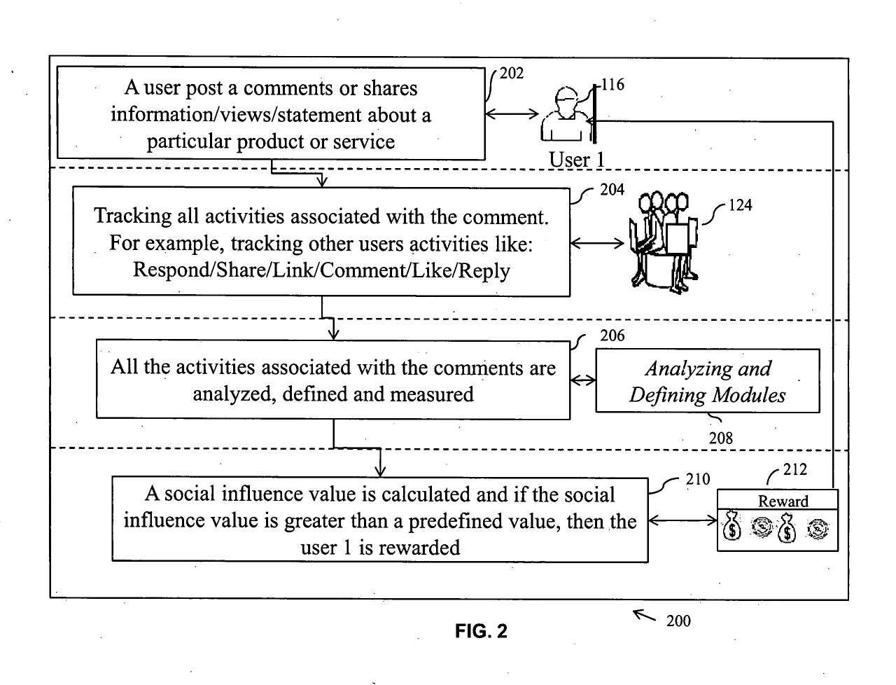

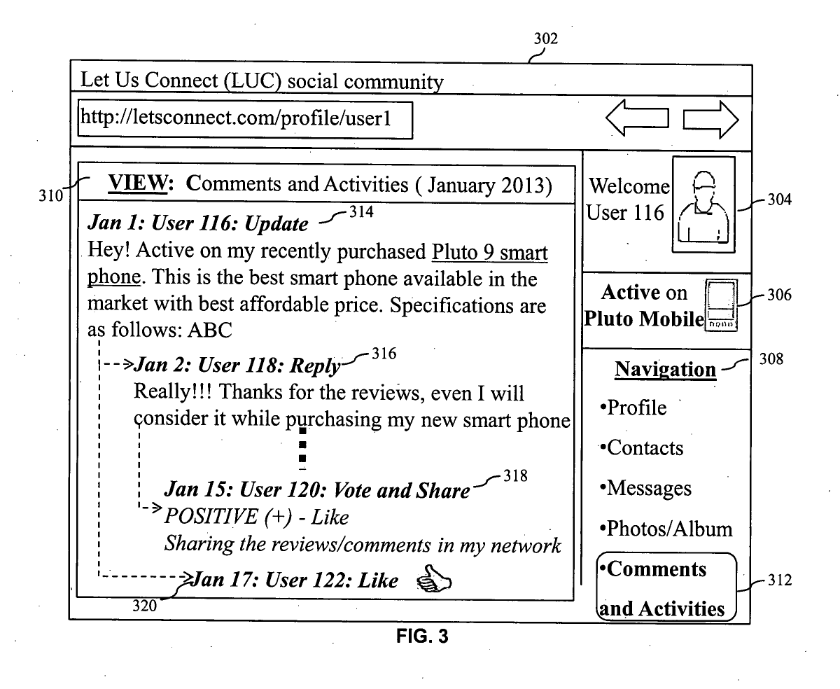

FIG. 2 illustrates a schematic flow diagram 200 of a system for social rewarding, in accordance with an exemplary embodiment. At step 202, the user 116 manually post a comments or shares information about a particular product or service in one of the element of the social media network 102. In an example, the comment is posted in the social networking website 104. An exemplary GUI such as a GUI 302 of the social networking website 104 is shown and described with respect to FIG. 3.

In an embodiment, a comment or information is automatically posted in response to actions performed by the user 116 and/or selections made by the user 116 in a predefined or dynamically created menu. The pre-defined menu may include different information and various options for selection. The user 116 can then select different options in the predefined menu to automatically create and post information on the social community website 104. The information may include data regarding brands, products, services, businesses, and the like. The various options may include words and phrases like ‘Love’, ‘Want to Buy’, ‘Purchased’, ‘Gifted’, ‘Wish to Have’, ‘Expecting a Gift’, and the like. For the sake of clarity, the method of automatically posting the comment is explained using the following example.

In an example, a predefined menu options are represented in the form of a tabular columns. The user 116 can select from two sets of tabular choices in a tabular menu options. The tabular menu option shown below is solely for the purpose of this description and do not limit the invention to the below exemplary representation.

| S. NO | PRODUCT | OPTIONS |
|---|---|---|
| 1. | Coffee: | Love, Want to Buy, Purchased, Gifted, |
| | Moon rucks, | Wish to Have, Expecting a Gift. |
| | StrongCafé | |
| 2. | Phone: | Love, Want to Buy, Purchased, Gifted, |
| | Pluto, 3star, Goldstar, | Wish to Have, Expecting a Gift. |
| | YesKian | |
| 3. | Shoes: | Love, Want to Buy, Purchased, Gifted, |
| | Kicke, Ramidas, | Wish to Have, Expecting a Gift. |
| | Freebuck | |
| 4. | Some-Object: | Love, Want to Buy, Purchased, Gifted, |
| | Brand1, Brand2, | Wish to Have, Expecting a Gift. |
| | BrandX | |

The user 116 from the above menu options can initially select a category of product, like ‘Coffee’, ‘Shoe’, ‘Phone’, and the like. Thereafter, the user 116 can select an option associated with the selected product, like ‘Purchased’, ‘Love’, ‘Want to Buy’, and the like. Thereafter, a statement is created based on context of the selected options. In the example, the user 116 selects ‘Pluto’ from the phonesection of the product column and thereafter selects ‘Purchased’ from the option column. Hence, a statement is created based on the context of the selections. An exemplary automated statement, posted on the social networking website 104 could be ‘Name of User 116’—‘Purchased’—‘Pluto Mobile’—on ‘Date’. In another example, the statement can even embed and/or include a logo of the ‘Pluto’ mobile in the statement.

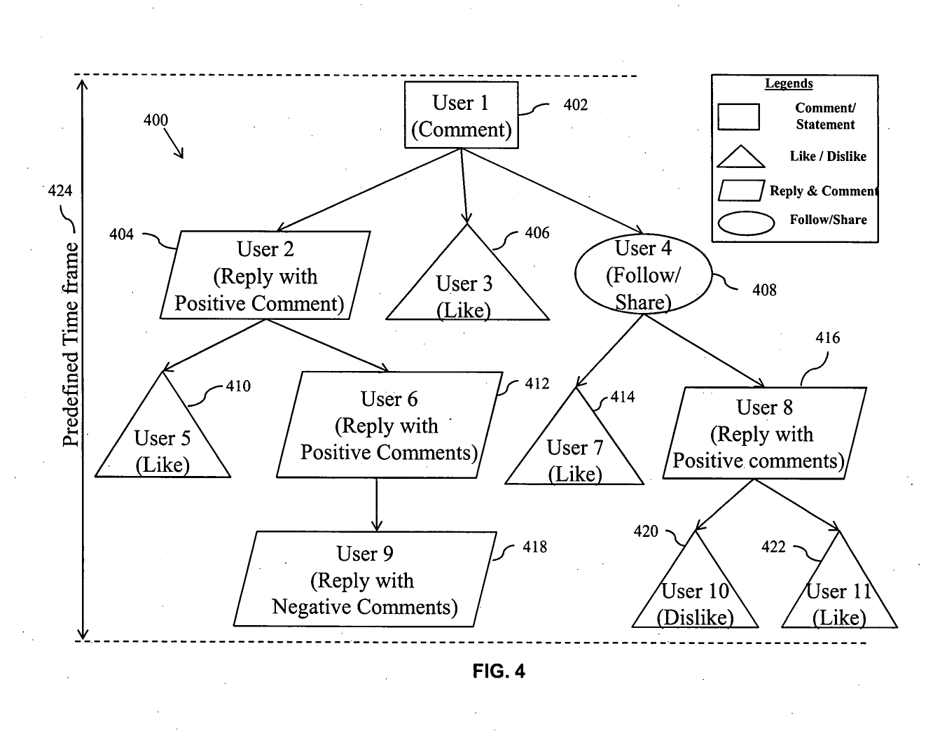

The statement posted by the user 116 can then be viewed by other users, for example the group of users 124 and thereafter various activities can be performed by each user in the group of users 124. For the sake of clarity and for the purpose of this description, the comment from the user 116 and the activities associated with the posted comment are further explained with respect to FIG. 3. The activities may include, but are not limited to, ‘Comment’, ‘Vote’, ‘Respond’, ‘Share’, ‘Link’, ‘Like’, ‘Dislike’ and ‘Reply’. At step 204, all the activities associated with the comment posted by the user 116 are tracked to identify a social influence trail of the posted comment. In an embodiment, the tracking is performed for a predefined timeframe. The step 204 is described further with respect to FIG. 4.

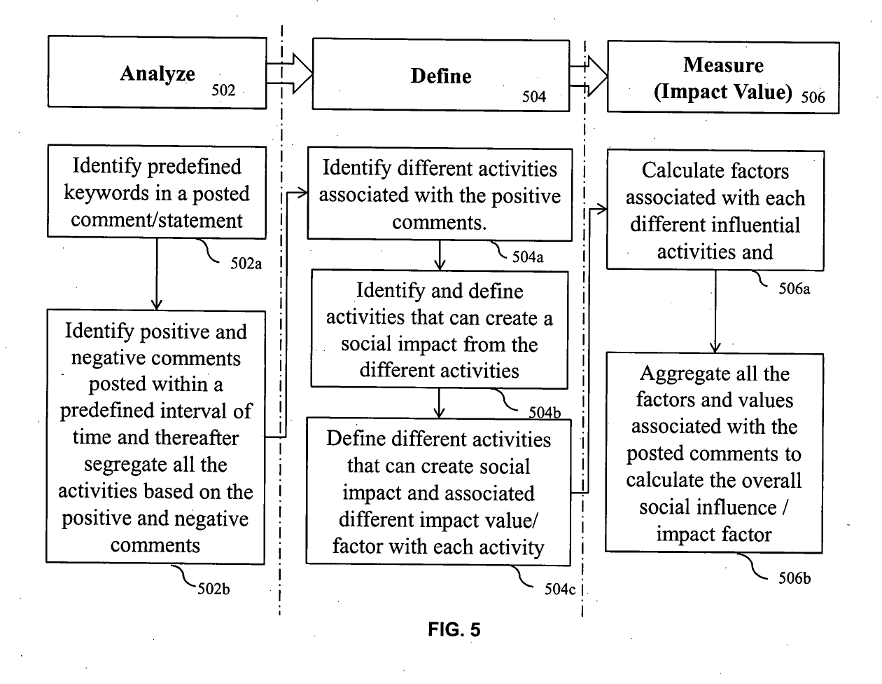

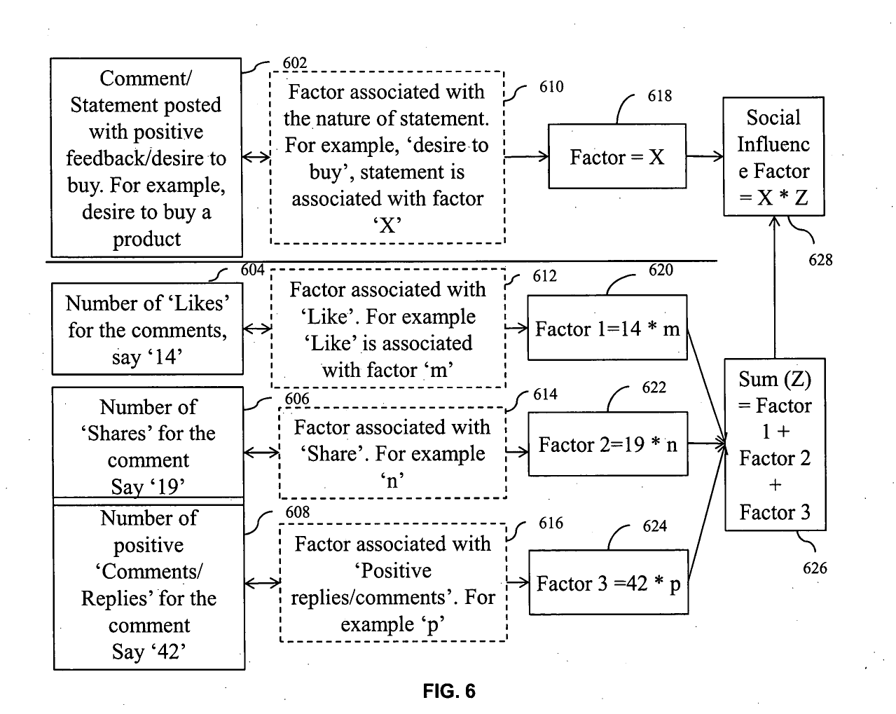

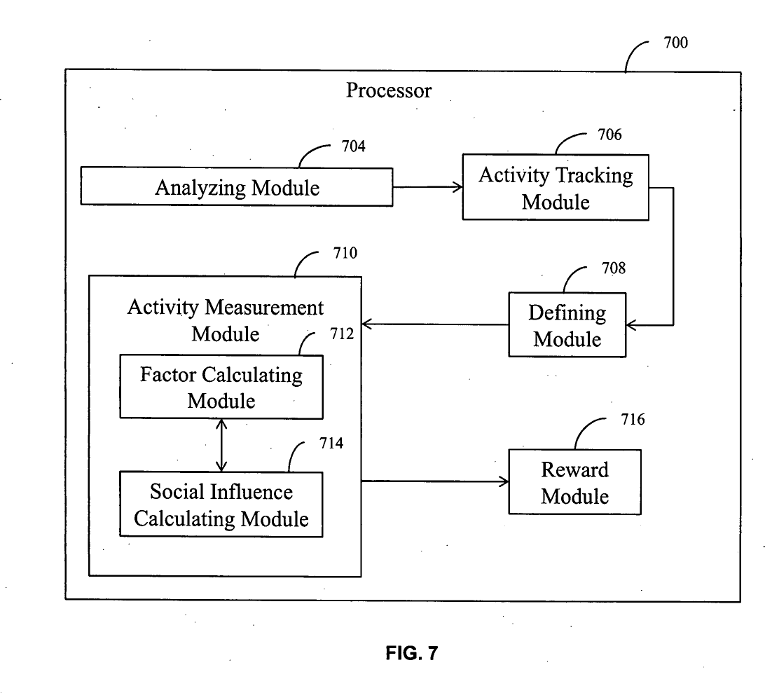

At step 206, all the activities associated with the posted comments are analyzed, defined and measured using an analyzing and defining module 208. The step 206 is further explained with respect to FIG. 5 and the analyzing and defining modules 208 are explained in conjunction with FIG. 7. At step 210, a social influence value of the posted comment is calculated and if the social influence value is greater than a threshold value then the user 116 is rewarded through a rewarding module (shown as 212). For the sake of clarity and for the purpose of this description, the step 210 is further explained in conjunction with FIG. 6.

FIG. 3 illustrates an exemplary Graphical User (GUI) interface of a social networking website such as the social networking website 104, in accordance with an exemplary embodiment. The GUI 302 shows a profile page of a user associated with the social networking website 104, for example, a ‘Let Us Connect (LUC)’ social networking website. The GUI 302 can be used by users of the network for creating profiles, share information with other users in a social network, and connect with other users. For the purpose of this description, profile of the user 116 is depicted in the GUI 302. In an embodiment, the profile can be accessed by the user 116 using different security measures like verifying login identity and password.

The GUI 302 is shown to include different sections like a profile picture section 304, a status section 306, a navigation section 308 and a view section 310. The profile picture section 304 can be used by the user 116 to upload a picture or an image. The status section 306 is used to post a status message like ‘Busy’, ‘Available’, ‘Do Not Disturb’, and the like. The status message can even post information regarding the electronic device used by the user 116 for accessing the profile, for example a mobile device, a laptop, and the like. In the exemplary embodiment, status of the user 116 is shown as ‘Available’ and the electronic device is a ‘mobile device’. The navigation section 308 includes different tabs. The different tabs allow the user 116 to view and update information associated with ‘Profile’, ‘Contacts’, ‘Messages’, ‘Photos/Albums’, and ‘Comments and Activities’.

The user 116 can select any tab provided in the navigation section 308 to view information associated with the selected tab in the view section 310. For example, all the comments and activities associated with the user 116 profile are displayed in the view section 310, if a ‘Comment and Activities’ tabs 312 is selected from the navigation section 308. Thus, the view section 310 includes an initial comment 314 (‘Update’) posted by the user 116 and a trail of activities associated with the comment 314. The trail of activities includes, but are not limited to, a ‘Reply’ 316 posted by the user 118, a ‘Vote and Share’ 318 posted by the user 120 and a ‘Like’ 316 posted by the user 122. It should be understood that the number of activities shown in the view section 310 are for the sake of clarity and can have any number of activities.

All the activities associated with the comment 314 are then analyzed and tracked to identify a social impact value of the comment 314. The social impact value is identified based on type of activities and number of activities associated with the comments 116. In an embodiment, only activities posted within a predefined timeframe are considered for identifying the social impact value. For example, if the predefined timeframe is 15 days for the comment 314 (that is posted on January 1), then the activity 316 will not be considered for evaluating the social impact value as it was posted on January 17. Finally, the user 116 is rewarded if the identified social impact value for the comment 314 is greater than a threshold value.

FIG. 4 illustrates an exemplary graphical representation of social influence trail, in accordance with an exemplary embodiment. The social influence trail 400 is represented in the form of structure tree. The structure tree is a way of representing hierarchical nature of a social influence trail 400 in a graphical form. However, it should be understood that the social trail 400 using may be represented in various form of graphical representations. The social influence trail 400 is initiated by user 1 (for example, the user 116) by posting a comment 402 on a social networking website. For example, the social trail is initiated when the user 116 post the comment 314 on the social networking website 302, as described in reference to FIG. 3. The comment 402 can then be viewed and replied by other users in the social network of the user 1. The other users can then perform one or more types of activities on the comment 402. For example, user 2 posts a ‘Reply with positive comments’ 404 to the comment 402, user 3 post a ‘Like’ 406 on the comment 402, and user 4 ‘follows/share’ 408 the comment 402 with other users in his/her social network. For the sake of clarity and for the purpose of this description, each of the one or more types of activities is pictorially represented using different shapes and design.

All the activities performed by the user 2, the user 3 and the user 4 can be further viewed by their respective social network contacts. For example, as user 5 and user 6 are associated with the user 2 in his/her corresponding social network, they can view all the activities associated with the comment 402 and can thereby react to the comment 402 by performing one or more activities. For example, a ‘Like’ 410 may be posted by the user 5 and a ‘Reply with positive comments’ 412 may be posted by the user 6. Subsequently, a user 9 from a social network of the user 6 may post a ‘reply with negative comments’ 418 on the reply posted by the user 6.

In a similar manner, user 7 and user 8 from the social network of the user 4 may react to the activities performed by the user 4 (for example, a ‘like’ 414 and a ‘Reply with positive comments’ 416). Likewise, user 10 and user 11 may react to the activities posted by the user 8 (for example, a ‘dislike’ 420 and a ‘like’ 422). Thus all the activities and the one or more types of activities collectively form a social influence trail 400. This social influence trail can then be analyzed to identify a social influence value or social impact value of the comment 402. In an embodiment, the activities performed within a predefined timeframe 424 are considered for calculating the social influence value. In an embodiment, negative activities (like the reply posted (shown by 418 and 420) are ignored while calculating the social influence value.

FIG. 5 illustrates different phases of calculation of a social influence value, in accordance with an exemplary embodiment. The phases include an analyze phase 502, a define phase 504 and a measure phase 506. In the analyze phase 502, all comments may be analyzed at step 502a to identify different keywords and phrases. The different keywords and phrases are then used to identify the type of comments, for example, positive comments, neutral comments or negative comments. Thereafter, at step 502b, all the activities are segregated under positive comments, negative comments, and neutral comments based on the keywords and phrases associated with the comments.

The define phase 504 is used to identify different activities associated with the positive comments at step 504a. The activities may include ‘Reply’, ‘Answer’, ‘Response’, ‘Feedback’, ‘Comment’ or a clicking option of ‘Like’, ‘Hail’, ‘Seen’, Read’, ‘Delete’ or ‘Wow’, for the positive comments. At step 504b, activities that can create a social impact are identified and defined. Examples of the activities that can create social impact includes, but are not limited to, selecting a ‘Like’, ‘Hail’ or ‘Wow’ option for the comment. Likewise, activities that includes ‘Seen’, ‘Read’, or ‘Delete’ option can be ignored, as these does not create any social impact. The activities are then defined in the system for future use and reference. At step 504c, different activities that can create the social impact are defined and different impact value/factor is associated with each activity from the different types of activities.

The measure phase 506, calculates the social influence/impact value of the comment. At step 506a, factors associated with each type of influential activity is calculated based on number of activities associated with each of the different type of activity and the social impact value (factor) associated with each type of activity. At step 506b, all the factors and values associated with the posted comments are aggregated to calculate overall social influence or impact factor. It should be noted that the factors considered for calculating the social influence value of the comment is solely for the purpose of this description and should not limit the scope of the invention to the referred factors. Calculation of the social influence value is further described with respect to the examples in FIG. 6.

FIG. 6 illustrates an example of calculating social influence values, in accordance with an exemplary embodiment. At step 602, a comment or a statement is posted with positive feedback of a product or a desire to buy a product. In the example, a timeframe is set and all activities created during this timeframe are tracked between the time of the posting of the statement and the closure of the timeframe. All the tracked activities are then analyzed to identify segregated one or more types of activities and number of occurrence associated with each type of activity. For example, a block 604 includes activities associated with ‘Like’, a block 606 includes activities associated with ‘Share’ and a block 608 includes activities associated with ‘Comments’. In an example, when the statement is posted on the social networking website (for example, on 104), the statement may receive one or more ‘Like’, ‘Share’ and ‘Comment’, for example 14 occurrences for ‘Likes’, 19 occurrences for ‘Shares’ and 42 occurrences for ‘Comments’.

Thereafter, each of the one or more types of activities is defined and associated with a factor multiplier/value. At step 610, a factor is associated with the initially posted statement based on nature of the statement. Similarly, different activities are associated with different factor multiplier. For example, if the nature of initial statement includes a phrase ‘Wants to Buy’ then factor multiplier is ‘X’. Likewise, at step 612, factor multiplier for ‘Like’ is defined as ‘m’ and at step 614, factor multiplier for ‘Share’ is defined as ‘n’. Further, at step 616, factor multiplier for ‘Positive Comment’ is defined as ‘p’. For the sake of clarity, the one or more types (also interchangeably referred to as “different types”) of activities and the factor multiplier, are summarised as follows: for the nature of statement posted at step 602, the factor multiplier is ‘X’, for 14 ‘Likes’, factor multiplier is ‘m’, for 19 ‘Shares’, factor multiplier is ‘n’ and for 42′Comments′, factor multiplier is ‘p’.

Further different factors associated with different activities may be computed. At step 618, the factor associated with the posted statement is identified and computed, for example ‘X’. At step 620, factor 1 associated with ‘Like’ is computed by multiplying the factor multiplier (m) with the count of activities (for example, 14). At step 622, factor 2 associated with ‘Share’ is computed by multiplying the factor multiplier (n) with the count of activities (for example, 19). At step 624, factor 3 associated with ‘Positive comment’ is computed by multiplying the factor multiplier (p) with the count of activities (for example, 42).

At step 626, all the factors associated with different activities are aggregated to identify response factor measured for reward. For example, the response factor (Z) is determined by summing factor 1, factor 2 and factor 3. In an embodiment, at step 628, a social influence value is identified by multiplying the response factor (Z) and the factor associated with the nature of statement (X), which in this case would be Z*X. The method used and values used are for the purpose of clarity and it should be noted that the person ordinary skilled in the art may use any other method and any values for calculating the social influence value.

The social influence value (Z*X) is the final reward factor for the statement posted at step 602. Thus, Z*X represents a particular number value as all the variables, like z, x, m, n, p, are predefined values. In an embodiment, the social influence value may correspond to amount of money, cash, or points to be given to a user who have posted the statement. In an embodiment, the socially influencing statements are rewarded by brand and website, which recognizes commercial potential of the user's statement that is created and made by the user.

In an embodiment, the amount Z*X is given to the user by representatives of the brand with which the product was associated and/or representatives of asocial/electronic media network on which the statement was posted. It must be noted here, that the representatives of the brand may pay an additional amount to the representatives of the social media network in context for being the medium of advertisement, which may be (Z*X)*Q, where ‘Q’ is the factor value for being the medium of advertisement.

FIG. 7 illustrates a processor including various modules for calculating social influence, in accordance with an exemplary embodiment. The processor 700 calculates the social influence value of a comment posted on electronic media content and thereafter causes to electronically reward the user of the comment based on predefined criteria.

The processor 700 includes various modules for calculating the social influence value and electronically rewarding the user. For example, the processor 700 is shown to include a analyzing module 704 which analyzes one or more comment posted on a social media network. The analysis of comments is explained in detail in reference, with FIG. 5. The analyzed comments are given as an input to an activity tracking module 706. The activity tracking module 706 tracks all activities associated with the comment and creates a social influence trail for the activities associated with the comment. Tracking of all the activities and creating the social influence trail is explained in detail in reference with FIG. 3 and FIG. 4.

The social influence trail and all the activities are then passed through a defining module 708. The defining module 708 analyzes the trail of activities to identify different types of activities and thereafter associate a factor multiplier with each type of activity. Analyzing the trail of activities and associating a factor multiplier is explained in detail in conjunction with FIG. 5 and FIG. 6. Further, the defined activities and the trail of activities are given as an input to an activity measurement module 710.

The activity measurement module 710 as illustrated in FIG. 7 includes a factor calculating module 712 and a social influence calculating module 714. The factor calculating module 712 calculates social factors value associated with each type of activity from the different types of activities. In an embodiment, the social factors value is calculated based on the number of activities associated with each type of activity and the factor multiplier values associated with the types of activities. The calculated social factors value associated with each type of activity is then given as input to the social influence calculating module 714.

The social influence calculating module 714 then calculates the social influence value of the comment based on the inputs received from the factor calculating module 712 and value associated with the nature of the comment. The steps performed by the activity measurement engine module 710 are explained in detailed in conjunction with FIG. 6. The calculated social influence value is then given as input to a reward module 716. The reward module 716 initially compares the calculated social influence value with a predefined value, and if the social influence value is greater than the threshold value then the reward module 716 rewards one or more users associated with the comment.

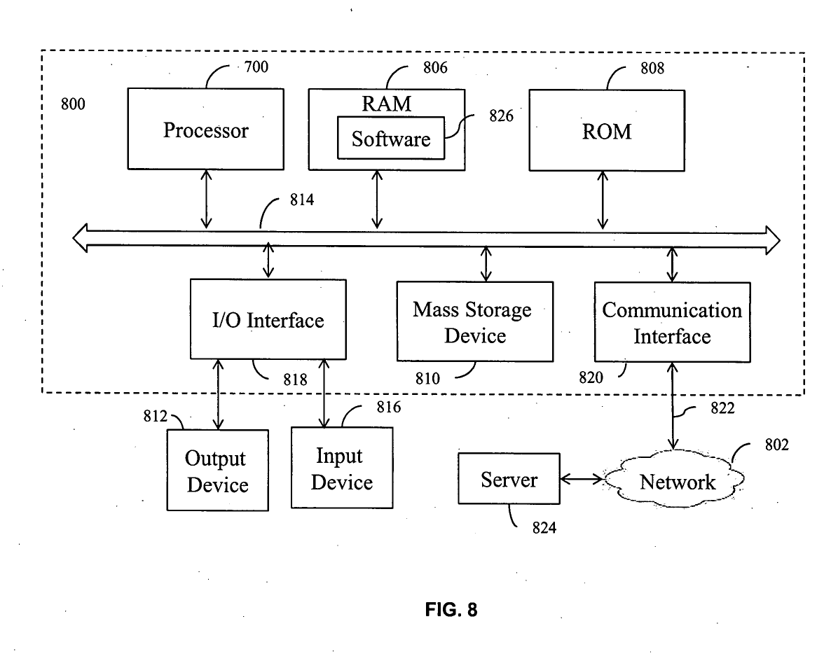

FIG. 8 illustrates a schematic view of a computer system, in accordance with an exemplary embodiment. The present invention may be performed in a variety of systems and combinations of systems, made up of functional components, such as the functional components described with reference to a computer system 800 and may be communicatively connected to a network, such as an interconnection network 802.

The computer system 800 includes a bus 814 or other communication device for communicating information within the computer system 800, and at least one hardware processing device, such as the processor 700, coupled to the bus 814 for processing information. The bus 814 preferably includes low-latency and higher latency paths that are connected by bridges and adapters and controlled within the computer system 800 by multiple bus controllers. When implemented as a server 824 or node, the computer system 800 may include multiple processors designed to improve network servicing power. Where multiple processors share the bus 814, additional controllers (not depicted) for managing bus access and locks may be implemented.

The processor 700 may be at least one general-purpose processor that, during normal operation, processes data under the control of a software 826, which may include at least one of application software, an operating system, middleware, and other code and computer executable programs accessible from a dynamic storage device such as random access memory (RAM) 806, a static storage device such as Read Only Memory (ROM) 808, a data storage device, such as mass storage device 810, or other data storage medium. The software 826 may include executable instructions including, but not limited to, code, applications, protocols, interfaces, and processes for controlling one or more systems within a network.

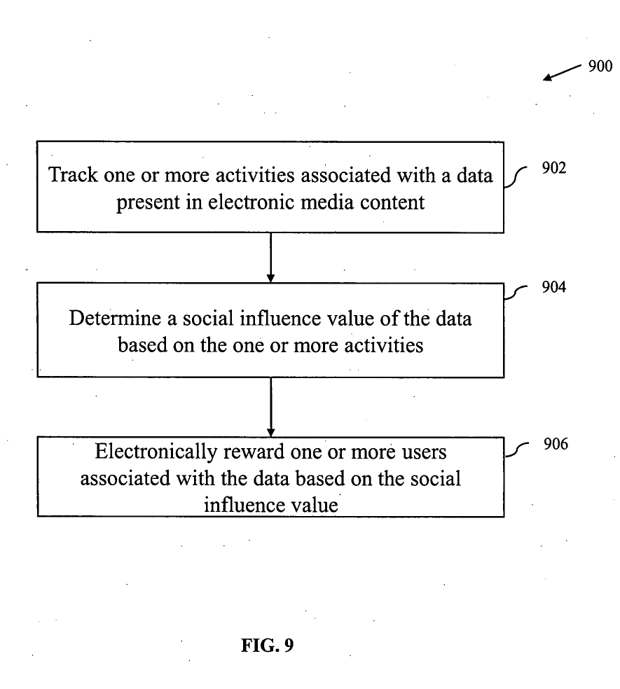

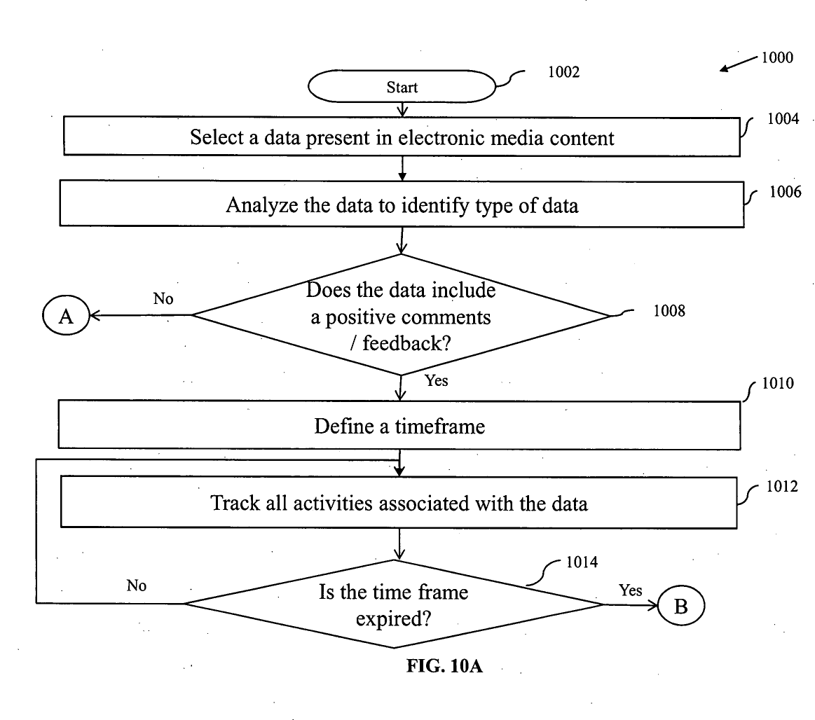

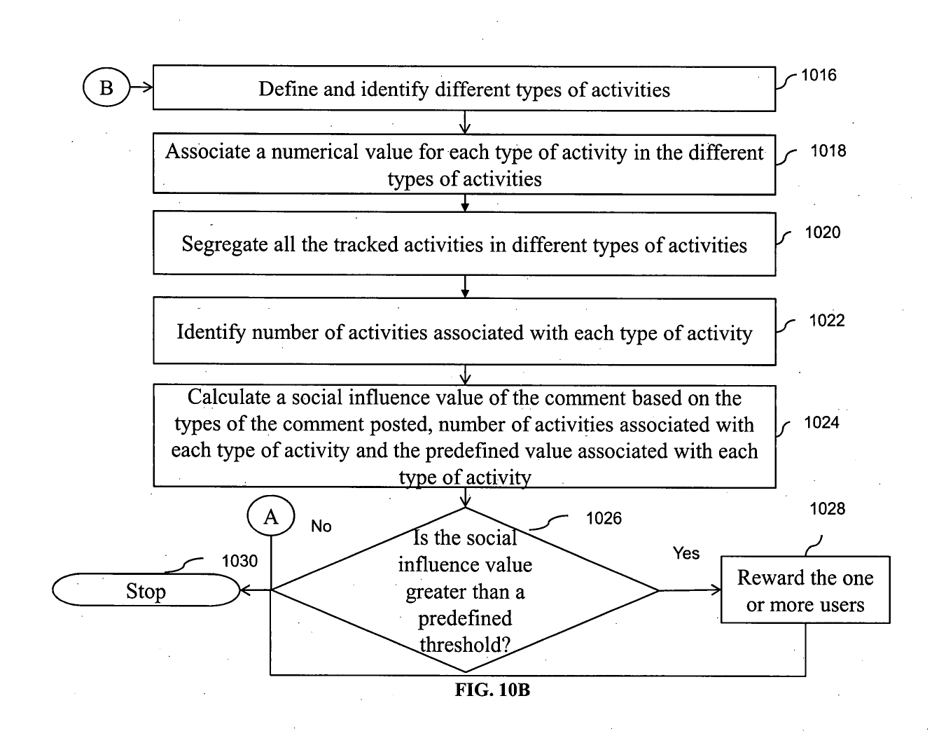

In one embodiment, the operations performed by the processor 700 may control the operations of flowchart of FIG. 9 and FIGS. 10A and 10B and other operations described herein. Operations performed by the processor 700 may be requested by the software 826 or other code or the steps of one embodiment of the invention might be performed by specific hardware components that contain hardwired logic for performing the steps, or by any combination of programmed computer components and custom hardware components.

It should be noted that aspects of one embodiment of the invention may be embodied as a system, method or computer program product. Accordingly, aspects of one embodiment of the invention may take the form of an entirely hardware embodiment, an entirely software embodiment (including firmware, resident software, micro-code, etc.) or an embodiment containing software and hardware aspects that may all generally be referred to herein as ‘circuit,’ ‘module,’ or ‘system.’ Furthermore, aspects of one embodiment of the invention may take the form of a computer program product embodied in one or more tangible and non-transitory computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, device, or any suitable combination of the foregoing. More specific examples (a non-exhaustive list) of the computer readable storage medium may include, an electrical connection having one or more wires, a portable computer diskette, a hard disk, such as the mass storage device 810, a random access memory (RAM), such as the RAM 806, the read-only memory (ROM) 808, an erasable programmable read-only memory (EPROM or Flash memory), an optical fiber, a portable compact disc read-only memory (CDROM), an optical storage device, a magnetic storage device, or any suitable combination of the foregoing. In the context of this document, a computer readable storage medium may be any tangible medium that can contain or store a program for use by or in connection with an instruction executing system, apparatus, or device.

A computer readable signal medium may include a propagated data signal with the computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction executable system, apparatus, or device.

Program code embodied on a computer readable medium may be transmitted using any appropriate medium, including but not limited to, wireless, wireline, optical fiber cable, radio frequency (RF), and the like, or any suitable combination of the foregoing.

Computer program code for carrying out operations of on embodiment of the invention may be written in any combination of one or more programming languages, including an object oriented programming language such as Java, Smalltalk, C++ or the like and conventional procedural programming languages, such as the ‘C’ programming language or similar programming languages. The program code may execute entirely on the user's computer, such as computer system 800, partly on the user's computer, as a stand-alone software package, partly on the user's computer and partly on a remote computer or entirely on the remote computer or server 826. In the latter scenario, the remote computer may be connected to the user's computer through any type of network, such as the interconnection network 802, through a communication interface, such as a network communication interface 820, over a network link that may be connected, for example, to the interconnection network 802.

In the example, the network communication interface 820 includes an adapter 822 for connecting the computer system 800 to the interconnection network 802 through a link. Although not depicted, the network communication interface 820 may include additional software, such as device drivers, additional hardware and other controllers that enable communication. When implemented as a server, the computer system 800 may include multiple communication interfaces accessible via multiple peripheral component interconnect (PCI) bus bridges connected to an input/output controller, for example. In this manner, the computer system 800 allows connections to multiple clients via multiple separate ports and each port may also support multiple connections to multiple clients.

These computer program instructions may also be stored in a computer-readable medium that can direct a computer, such as the computer system 800, or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer, such as the computer system 800, or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The network communication interface 820, the network link to the interconnection network 802, and the interconnection network 802 may use electrical, electromagnetic, or optical signals that carry digital data streams. The signals through the various networks and the signals on the interconnection network 802, the network link to the interconnection network 802, and the network communication interface 820 which carry the digital data to and from the computer system 800, may be forms of carrier waves transporting the information.

In addition, the computer system 800 may include multiple peripheral components that facilitate input and output. These peripheral components are connected to multiple controllers, adapters, and expansion slots, such as an input/output (I/O) interface 818, coupled to one of the multiple levels of a bus 814. For example, an input device 816 may include, for example, a microphone, a video capture device, an image scanning system, a keyboard, a mouse, or other input peripheral device, communicatively enabled on the bus 814 via I/O interface 818 controlling inputs. In addition, for example, output device 812 communicatively enabled on the bus 814 via the I/O interface 818 for controlling outputs may include, for example, one or more graphical display devices, audio speakers, and tactile detectable output interfaces, but may also include other output interfaces. In alternate embodiments of the present invention, additional or alternate input and output peripheral components may be added.

Those of ordinary skill in the art will appreciate that the hardware depicted in FIG. 8 may vary. Furthermore, those of ordinary skill in the art will appreciate that the depicted example is not meant to imply architectural limitations with respect to the present invention.

Some embodiments of the invention are described below with reference to flowchart illustrations and/or block diagrams of methods, apparatus (systems) and computer program products according to embodiments of the invention. Those of ordinary skill in the art will appreciate that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

FIG. 9 is a flowchart depicting an exemplary method 900 of the social rewarding, in accordance with an exemplary embodiment of the present technology. The method 900 depicted in the flow chart may be executed in various scenarios, for example in the environment 100. Further, the method 900 may be executed by a processing system, for example, the processor 700. Operations of the flowchart, and combinations of operation in the flowchart, may be implemented by various means, such as hardware, firmware, computing device, circuitry and/or other device associated with execution of software including one or more computer program instructions of the processor 700.

At block 902, a processor such as the processor 700 tracks one or more activities associated with a data present in electronic media content. The electronic media is a social media network. Examples, of social media network include, but are not limited to, social networking website, online blogs and micro blogs, media sharing websites, online forums and information websites. The data present in the electronic media can be a comment, web content, Uniform Resource Locator (URL) or a feedback. In an embodiment, the data is posted by one or more users on the social media network. The one or more activities include, but are not limited to, ‘Reply’, ‘Answer’, ‘Response’, or ‘Feedback’ posted for the comment by other users in the social network.

At block 904, the processor determines a social influence value of the data based on the one or more activities. The processor, for determining the social influence value, tracks the one or more activities and then identifies types of activities in the one or more activities. Further, the processor identifies a count of number of occurrence associated with each type of activity of the one or more activities. In an embodiment, each types of activity can be associated with a predefined value. Thus, the processor determines the social influence value using predefined values associated with different types of activities and the count of number of occurrence of each type of activity of the different types of activities.

At block 906, the processor electronically rewards one or more users associated with the data based on the social influence value. The rewards are awarded to the one or more users if the social influence value of the posted comment is greater than a threshold value.

FIGS. 10A and 10B area flowchart depicting an exemplary method 1000 of the social rewarding, in accordance with another exemplary embodiment of the present technology. The method 1000 depicted in the flow chart may be executed in various scenarios, for example the environment 100. Further, the method 1000 may be executed by a processing system, for example, the processor 700 embodied in a computer system such as the computer system 800. Operations of the flowchart, and combinations of operation in the flowchart, may be implemented by various means, such as hardware, firmware, computing device, circuitry and/or other device associated with execution of software including one or more computer program instructions of the processor 700.

At step 1002, the method 1000 is initiated. At step 1004, a processor such as the processor 700 select a data present in electronic media content. Examples of data include, but are not limited to, a text message, a picture, a Uniform Resource Locator (URL) and an automated message drawn in response to an activity of the user. In an embodiment, the user 116 manually post a comments or shares information about a particular product or service in a social media network 102. In another embodiment, a comment or information is automatically posted in response to actions performed by the user 116 and/or selections made by the user 116 in a predefined or dynamically created menu. The predefined menu may include different information and various options for selection. The user 116 can then select different options in the predefined menu to automatically create and post information (comment) on the social community website 302. The information may include data regarding brands, products, services, businesses, and the like. The various options may include words and phrases like ‘Love’, ‘Want to Buy’, ‘Purchased’, ‘Gifted’, ‘Wish to Have’, ‘Expecting a Gift’, and the like. In an example, the processor selects a comment 314 (a text message) posted by the user 116 on the social community website 302.

At step 1006, the processor analyzes the data to identify type of data. For example, the type of data includes positive information, neutral information, or negative information. In an embodiment, the data is analyzed by extracting keywords and phrases from the data. For example, after analyzing the data (for example, the comment 314) posted by the user 116, keywords such as ‘Pluto Mobile’, ‘Purchased’, ‘Affordable Price’, ‘Best smart phone’ and ‘specifications’ are extracted. At step 1008, the processor checks if the data present in the electronic media includes a positive comment based on the extracted keywords. If the data includes a positive comment, A the method 1000 proceeds to a step 1010, otherwise the method 1000 is terminated at step 1030.

At step 1010, a timeframe is defined. In an embodiment, the timeframe is defined in hours, days, months and/or years. In an example, the timeframe in the method 1000 is defined as 15 days. The timeframe is defined for tracking activities only within that predefined timeframe. At step 1012, the processor tracks all activities associated with the data within the predefined timeframe. For example, activities (such as the activities 316 and 318) posted within the predefined timeframe are tracked for the comment 314 and an activity (such as the activity 320) is ignored if it was not posted within the predefined timeframe of 15 days. At step, 1014, the method 1000 checks the timeframe expiration. If the timeframe has not expired then the step 1012 is performed otherwise step 1016 is performed. In an embodiment, only positive activities and/or the activities associated with positive comments that are capable of creating social impact are tracked. The different types of activities may include, but are not limited to, ‘Reply’, ‘Answer’, ‘Response’, ‘Feedback’, ‘Comment’ or clicking an option of ‘Like’, ‘Hail’, ‘Seen’, Read’, ‘Delete’, ‘Tag’, or ‘Wow’. Thus, the activities that can create social impact are tracked, for example selection of ‘Like’, ‘Hail’ or ‘Wow’ option for the comment may be considered. Likewise, activities that includes selection of ‘Seen’, ‘Read’, or ‘Delete’ option can be ignored, as these activities does not create any social impact.

At step 1016, the processor identifies and defines one or more types of activities from the one or more activities. The one or more types of activities include, but are not limited to, sharing the data, replying to the data, indicating a like to the data, indicating a dislike to the data, following the data, voting for the data, tagging the data, and the like. At step 1018, the processor associates a predefined value (such as a numerical value) with each type of activity of the one or more activities. The numerical value is a factor multiplier for the different types of activity. In an example, the factor multiplier is ‘X’ for the nature of comment that is initially posted. Similarly, the factor multiplier for ‘Likes’ is ‘m’, for ‘Shares’ is ‘n’ and for comments is ‘p’.

At step 1020, the processor segregates all the tracked activities based on different types of activities. At step 1022, number of activities (count of occurrence) associated with each type of activity is identified. For example, a comment posted on a social networking website may receive 14 ‘Likes’, 19 ‘Shares’ and 42 ‘Comments’. At step 1024, the processor calculates a social influence value of the comment based on the types of the comment posted, number of activities associated with each type of activity and the predefined value associated with each type of activity of the one or more activities. Calculation of social influence value is explained in detail in reference with FIG. 6.

In the embodiment, the social influence value is identified by first, calculating factors associated with each of the different types of activities. The factors are calculated by multiplying the number of activities associated with each type of activity with their corresponding factor multiplier, for example, 14*m for ‘like’ activity, 19*n for ‘Share’activity and 42*p for ‘comments’ activity. Thereafter, the social influence value is calculated by summing all the calculated factors and thereafter multiplying the sum, with the factor multiplier associated with the nature of the posted comment. For example, the social influence value is X*(14*m+19*n+42*p).

At step 1026, the processor compares the social influence value with a predefined threshold. If the social influence value is greater than a threshold value then a step 1028 is performed otherwise the step 1030 is performed. At step 1028, the one or more users associated with the comment are rewarded. At step 1030, the method 1000 is terminated.

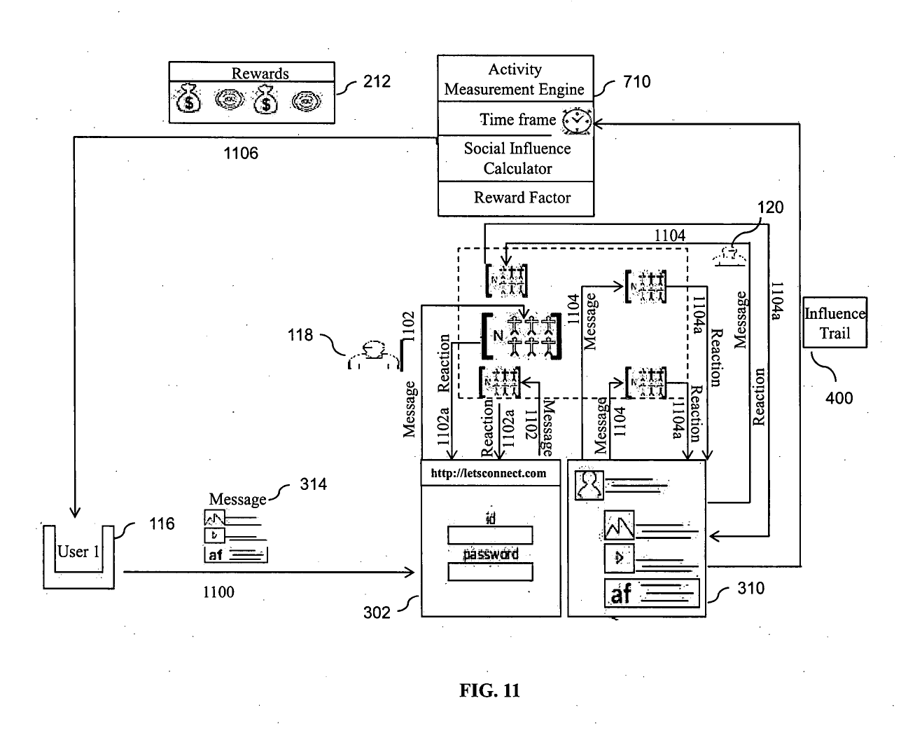

FIG. 11 illustrates a schematic representation of social rewarding in accordance with an exemplary embodiment. At step 1100, the user 116 posts a data (for example, the comment or message 314) in an electronic media content (for example, the social networking website 302). In an embodiment, a user identity and password is entered for authentication in the social networking website 302. The message 314 can then be read by other users in the social network of the user 116. Hence, the user 118 reads the message 314 and reacts to the message. All the activities of the user 118 on the message 314 are referred using step 1102 and 1102a. For example, the step 1102 is associated with reading of the message 314 by the user 118 and the step 1102a is associated with reactions of the user 118 on the message 314.

Similarly, the activities associated with the user 120 are represented using steps 1104 and 1104a. For example, the step 1104 is associated with reading of the message 314 by the user 120 and the step 1104a is associated with reactions of the user 120 on the message 314. All the activities associated with the message 314 are tracked and analyzed by the processor. The social influence trail 400 is then created the message 314 posted by the user 116. The social influence trail 400 is then given as an input to the activity measurement engine 710 for further processing. The activity measurement engine 710 is shown to include a timeframe module, a social influence calculator module and a reward factor module. The social influence trail 400 is then analyzed by the activity measurement engine 710 to identify the rewards for the user 116 based on the social influence created by the message 314. At step 1106, the user 116 is rewarded by the rewarding module 212.

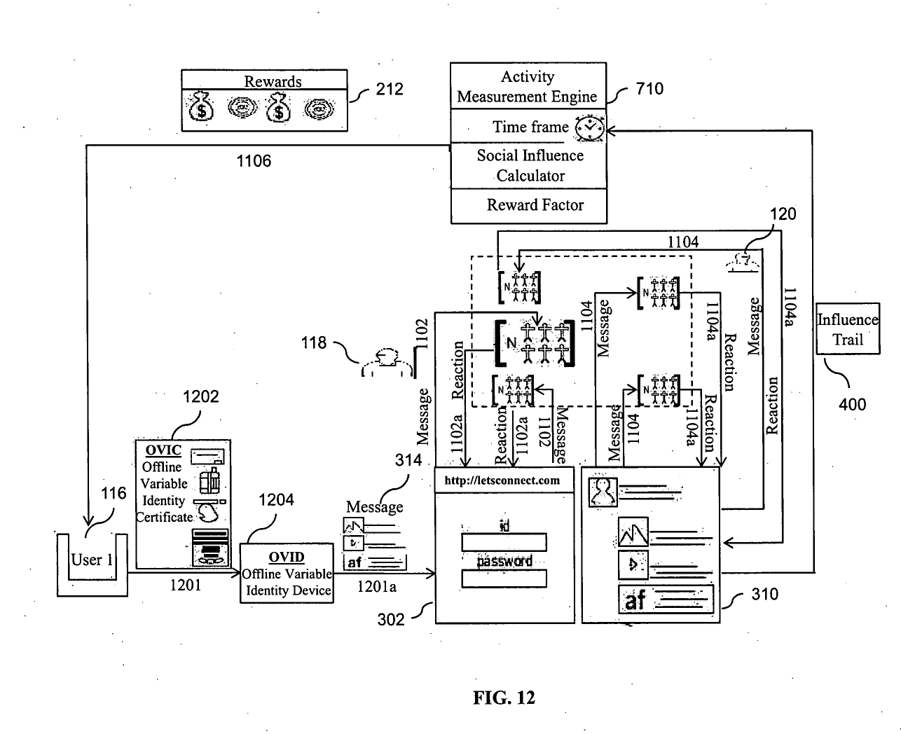

FIG. 12 illustrates a schematic representation of social rewarding in accordance with another exemplary embodiment of the present technology. At step 1201, the user 116 interacts using Offline Verifiable Identity Certificate (OVIC) 1202 with an Offline Verifiable Identity Device (OVID) 1204. In the exemplary embodiment, the message was not directly posted by the user manually but is posted automatically in response to an action of the user 116 with an OVIC on an electronic device associated with the user 116. In an embodiment, the OVIC and OVID enable the user 116 to post offline messages. The offline message can then be posted on the social networking website 302 after a specific period of time based on predefined criteria associated with OVIC and OVID.

At step 1201a, a message 314 corresponding to the action of the user 116 is posted on a social networking website 302. In an embodiment, a user identity and password is entered for authentication in the social networking website 302. The message 314 can then be read by other users in the social network of the user 116. Hence, the user 118 reads the message 314 and reacts to the message. All the activities of the user 118 on the message 314 are referred using step 1102 and 1102a. For example, the step 1102 is associated with reading of the message 314 by the user 118 and the step 1102a is associated with reactions of the user 118 on the message 314.

Similarly, the activities associated with the user 120 are represented using steps 1104 and 1104a. For example, the step 1104 is associated with reading of the message 314 by the user 120 and the step 1104a is associated with reactions of the user 120 on the message 314. All the activities associated with the message are tracked and analyzed by the processor. The social influence trail 400 is then created for the message 314 generated/posted by the user 116. The social influence trail 400 is then given as an input to the activity measurement engine 710 for further processing. The activity measurement engine 710 is shown to include a timeframe module, a social influence calculator module and a reward factor module. The social influence trail is then analyzed by the activity measurement engine 710 to identify the rewards for the user 116 based on the social influence created by the message 314. At step 1106, the user 116 is electronically rewarded by the rewarding module 212.

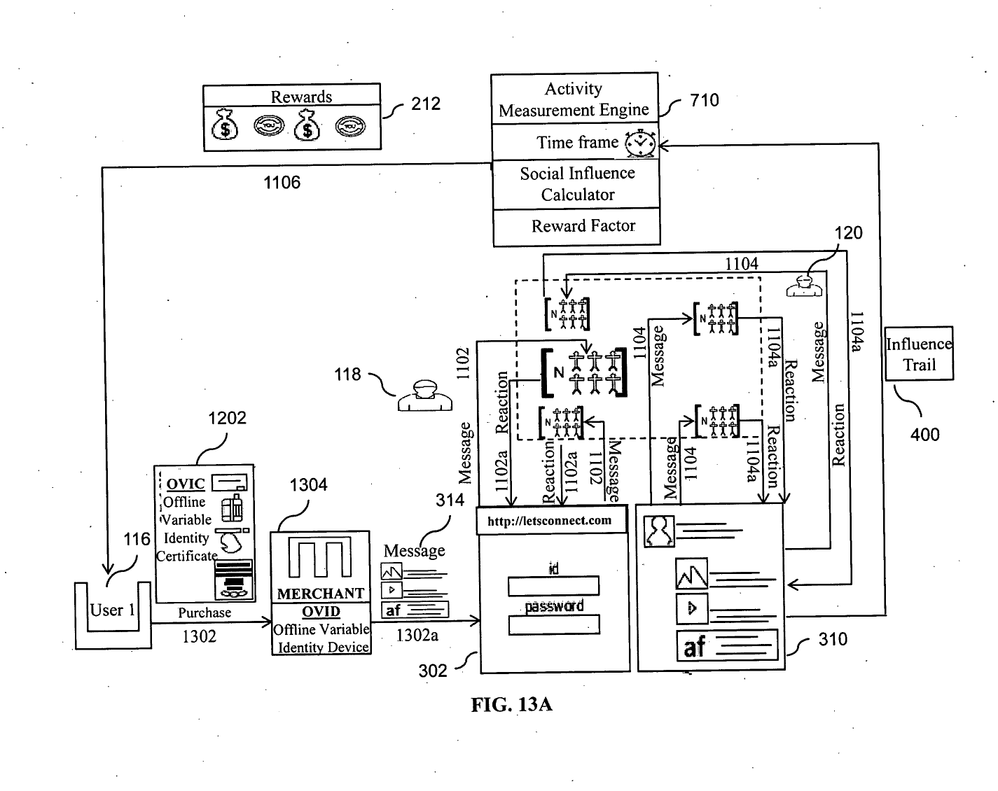

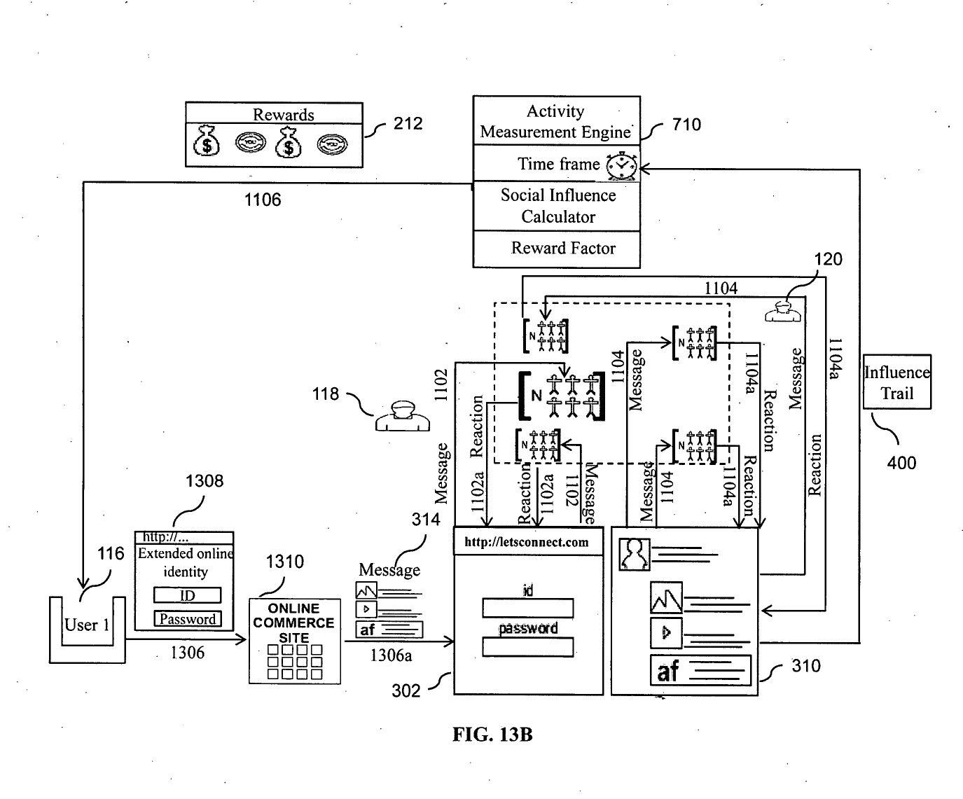

FIGS. 13A and 13B illustrate a schematic representation of social rewarding in accordance with still another exemplary embodiment of the present technology.

Referring to FIG. 13A, at step 1302, the user 116 interacts using Offline Verifiable Identity Certificate (OVIC) 1202 with an Offline Verifiable Identity Device (OVID) at a merchant establishment (represented by 1304). In this exemplary embodiment, a message may be posted automatically in response to the user's action of purchase with the OVIC on an electronic device at a merchant establishment. At step 1302a, the action of purchase leaves an offline-triggered online status message 314 on a website.

At step 1302a, the message 314 corresponding to this user action 116 is posted on a social networking website 302. In an embodiment, a user identity and password is entered for authentication in the social networking website 302. The message 314 can then be read by other users in the social network of the user 116. For example, the user 118 reads the message 314 and reacts to the message. All the activities of the user 118 on the message 314 are referred using step 1102 and 1102a. For example, the step 1102 is associated with reading of the message 314 by the user 118 and the step 1102a is associated with reactions/activity performed by the user 118 on the message 314.

Similarly, the activities associated with the user 120 are represented using steps 1104 and 1104a. For example, the step 1104 is associated with reading of the message 314 by the user 120 and the step 1104a is associated with reactions/activities performed by the user 120 on the message 314. All the activities associated with the message are tracked and analyzed by the processor. The social influence trail 400 is then created for the message 314 posted by the user 116. The social influence trail 400 is then given as an input to the activity measurement engine 710 for further processing. The activity measurement engine 710 is shown to include a timeframe module, a social influence calculator module and a reward factor module. The social influence trail is then analyzed by the activity measurement engine 710 to identify the rewards for the user 116 based on the social influence created by the message 314. At step 1106, the user 116 is electronically rewarded by the rewarding module 212.

Referring to FIG. 13B, the user 116 makes a purchase at step 1306 using an Offline Verifiable Identity Certificate (OVIC) or Extended online identity 1308 of a website at a Merchant's Online e-commerce website 1310. The action to purchase by the user 116 impacts an activity to leave an offline-triggered online status message on a website. At step 1306a, the message 314 is automatically posted in response to the user's action of purchase.

At step 1306a, the message 314 corresponding to this action of the user 116 is posted on a social networking website 302. In an embodiment, a user identity and password is entered for authentication in the social networking website 302. The message 314 can then be read by other users in the social network of the user 116. Hence, the user 118 reads the message 314 and reacts to the message. All the activities of the user 118 on the message 314 are referred using step 1102 and 1102a. For example, the step 1102 is associated with reading of the message 314 by the user 118 and the step 1102a is associated with reactions/activities performed by the user 118 on the message 314.

Similarly, the activities associated with the user 120 are represented using steps 1104 and 1104a. For example, the step 1104 is associated with reading of the message 314 by the user 120 and the step 1104a is associated with reactions/activities performed by the user 120 on the message 314. All the activities associated with the message are tracked and analyzed by the processor. The social influence trail 400 is then created and for the message 314. The social influence trail 400 is then given as an input to the activity measurement engine 710 for further processing. The activity measurement engine 710 is shown to include a timeframe module, a social influence calculator module and a reward factor module. The social influence trail is then analyzed by the activity measurement engine 710 to identify the rewards for the user 116 based on the social influence created by the message 314. At step 1106, the user 116 is rewarded by the rewarding module 212.

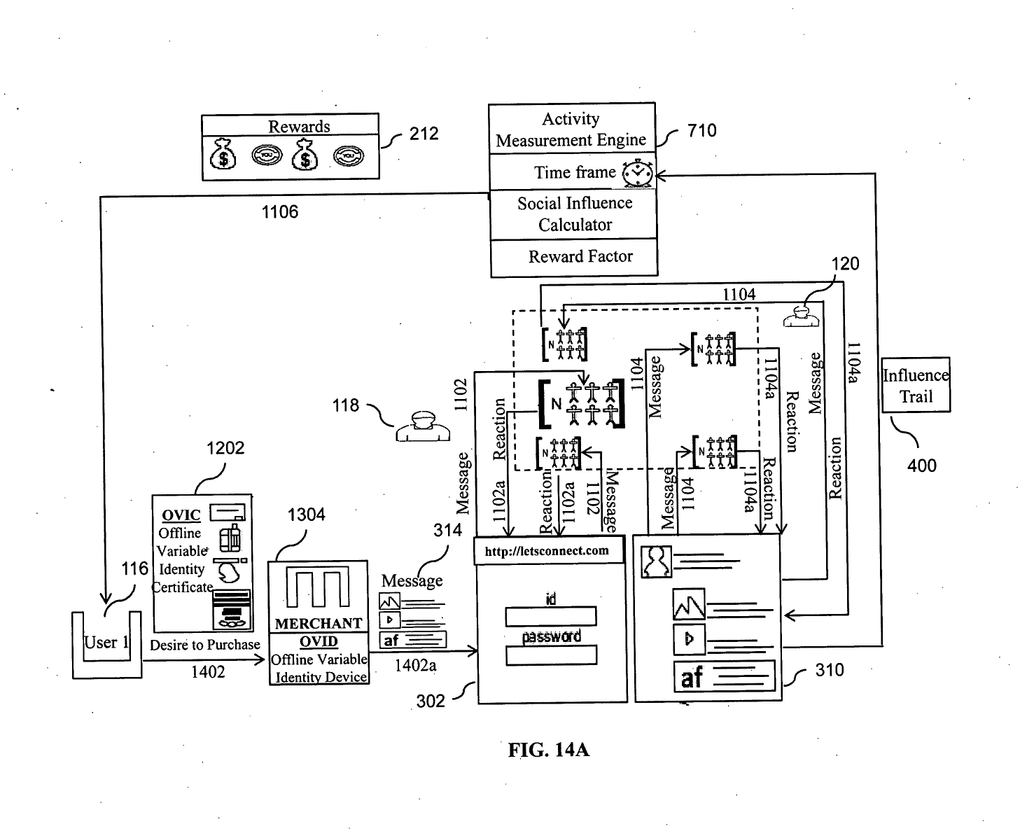

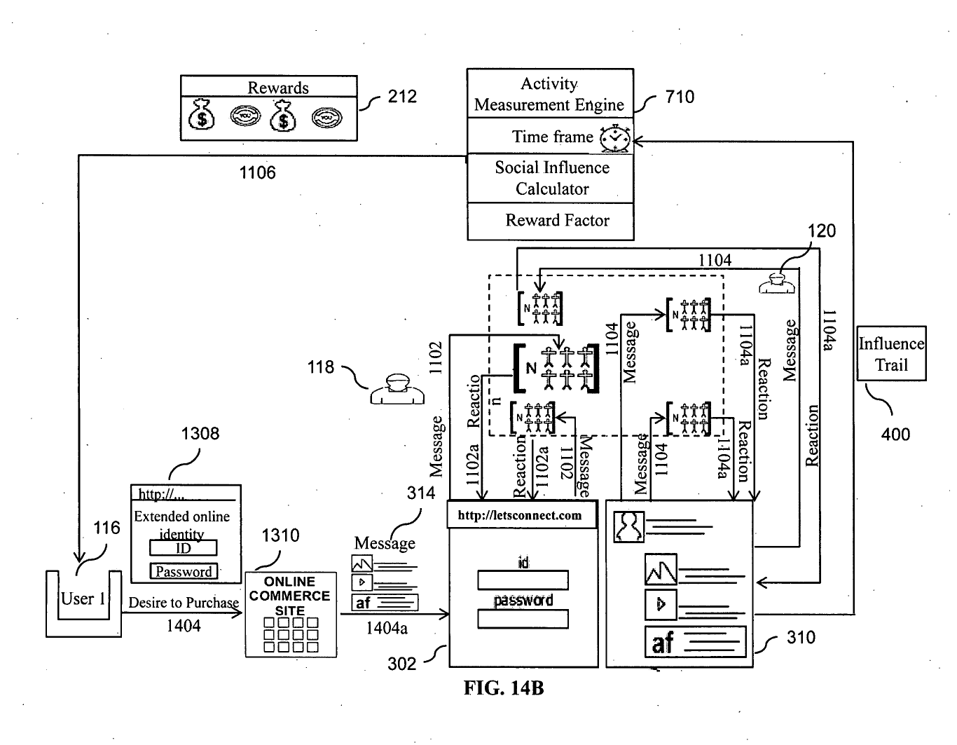

FIGS. 14A and 14B illustrate a schematic representation of social rewarding in accordance with yet another exemplary embodiment of the present technology.

Referring to FIG. 14A, at step 1402, the user 116 interacts using Offline Verifiable Identity Certificate (OVIC) 1202 with an Offline Verifiable Identity Device (OVID) at a merchant establishment (shown as 1304). In the exemplary embodiment, the message was posted automatically in response to the user's action of desire to purchase with the OVIC on an electronic device at the merchant establishment 1304. The action of desire to purchase leaves an offline-triggered online status message 314 on a website.

At step 1402a, the status message 314 corresponding to the user action is posted on a social networking website. For example a message 314 is posted on the social networking website 302. In an embodiment, a user identity and password is entered for authentication. The message 314 can then be read by other users in the social network of the user 116. Hence, the user 118 reads the message 314 and reacts to the message. All the activities associated with the user 118 on the message 314 are referred using step 1102 and 1102a. For example, the step 1102 is associated with reading of the message 314 by the user 118 and the step 1102a is associated with reactions of the user 118 on the message 314.

Similarly, the activities associated with the user 120 are represented using steps 1104 and 1104a. For example, the step 1104 is associated with reading of the message 314 by the user 120 and the step 1104a is associated with reactions/activities performed by the user 120 on the message 314. All the activities associated with the message are tracked and analyzed by the processor. The social influence trail 400 is then created for the message 314 posted by the user 116. The social influence trail 400 is then sent to the activity measurement engine 710 for further processing. The social influence trail is then analyzed by the activity measurement engine 710 to identify the rewards for the user 116 based on the social influence created by the message 314. At step 1106, the user 116 is rewarded.

Referring to FIG. 14B, the user 116 makes a desire to purchase at step 1404 using an Offline Verifiable Identity Certificate (OVIC) 1202 or Extended online identity 1308 of a website at a Merchant's Online e-commerce website 1310. The desire to purchase 1404 by the user 116 impacts an activity to leave an offline-triggered online status message 314 on a website. Hence, the particular message is automatically posted in response to the user's action of desire to purchase.

At step 1404a, the status message 314 corresponding to the user action is posted on a social networking website. For example the message 314 is posted on the social networking website 302. In an embodiment, a user identity and password is entered for authentication. The message 314 can then be read by other users in the social network of the user 116. Hence, the user 118 reads the message 314 and reacts to the message. All the activities associated with the user 118 on the message 314 are referred using step 1102 and 1102a. For example, the step 1102 is associated with reading of the message 314 by the user 118 and the step 1102a is associated with reactions/activities performed by the user 118 on the message 314.

Similarly, the activities associated with the user 120 are represented using steps 1104 and 1104a. For example, the step 1104 is associated with reading of the message 314 by the user 120 and the step 1104a is associated with reactions of the user 120 on the message 314. All the activities associated with the message are tracked and analyzed by the processor. The social influence trail 400 is then created for the message 314 posted by the user 116. The social influence trail 400 is then sent to the activity measurement engine 710 for further processing. The social influence trail is then analyzed by the activity measurement engine 710 to identify the rewards for the user 116 based on the social influence created by the message 314. At step 1106, the user 116 is rewarded.

Various embodiments, as discussed above, provide method and system of social rewarding. The method recognizes and rewards a user, if activities associated with the user on the social media network creates a social impact on other users in a social network. The method increases publicity of products and/or services effectively and economically. The method indirectly provides an option to merchants and service providers to market their products and/or services using an additional internet source like comments section in social media rather than paid advertisements. Further, the method allows the merchants and the service providers to target international market as the users may have international social contacts. The method will also allow the merchants and service providers to improve their products and/or services based on the negative comments received by the users. The method also enables the comments and awareness to reach audiences of all ages, as the social network of users may include users of different ages.

Common forms of non-transitory computer-readable storage medium include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer may read.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

What is claimed is:

1. A computer implemented method, comprising:
a. tracking one or more activities associated with a data present in an electronic media content;
b. determining a social influence value of the data based on the one or more activities; and
c. electronically rewarding one or more users associated with the data based on the social influence value.

2. The method of claim 1, further comprising:
a. analyzing the one or more activities to identify one or more types of activities in the one or more activities; and
b. associating a predefined value with each type of activity of the one or more types of activities.

3. The method of claim 2, wherein the determining comprises:
a. identifying count of occurrence associated with each type of activity of the one or more types of activities; and
b. calculating the social influence value of the data based on the predefined values associated with the each types of activity and the count of occurrence associated with the each type of activity.

4. The method of claim 3, wherein the determining further comprises:
calculating the social influence value based on a factor multiplier associated with the data.

5. The method of claim 1, wherein the tracking of the one or more activities is performed for a predefined timeframe.

6. The method of claim 1, wherein the electronically rewarding is performed if the social influence value is greater than a threshold value.

7. The method of claim 1, wherein the one or more activities is at least one, of sharing the data, replying to the data, indicating a like to the data, indicating a dislike to the data, following the data, voting for the data, and tagging the data.

8. The method of claim 1, wherein the electronic media content is at least one of a social networking website, online blogs, online forums, media sharing websites, and information website.

9. The method of claim 1, wherein the data is at least one of a text message, a picture, a Uniform Resource Locator (URL) and an automated message drawn in response from an activity.

10. The method of claim 1, wherein the data includes feedback of at least one of a product and a service comprising at least one of positive information, negative information and a neutral information.

11. The method of claim 1, wherein the data is at least one of:
a. manually posted by the one or more users utilizing an input system; and
b. automatically posted by an automated communication system in response to the actions performed by the one or more users.

12. A computer system, comprising:
a. a memory to store instructions; and
b. one or more processors responsive to stored instructions to perform
c. tracking one or more activities associated with a data present in an electronic media content,
d. determining a social influence value of the data based on the one or more activities, and
e. electronically rewarding one or more users associated with the data based on the social influence value.

13. The computer system of claim 12, wherein the one or more processors is responsive to stored instructions to further perform:
a. analyzing the one or more activities to identify one or more types of activities in the one or more activities; and
b. associating a pre-defined value with each type of activity of the one or more types of activities.

14. The computer system of claim 13, wherein the one or more processors is responsive to stored instructions to further perform:
a. identify count of occurrence associated with each type of activity of the one or more types of activities; and
b. calculate the social influence value of the data based on the predefined values associated with the each type of activity and the count of occurrence associated with the each type of activity.

15. The computer system of claim 14, wherein the one or more processor is responsive to stored instructions to further perform:
calculating the social influence value based on a factor multiplier associated with the data.

16. The computer system of claim 12, wherein the one or more processor is responsive to stored instructions to perform tracking the one or more activities for a predefined timeframe.

17. The computer system of claim 12, wherein the one or more processor is responsive to stored instructions to perform electronically rewarding if the social influence value is greater than a threshold value.

18. The computer system of claim 12, wherein the one or more activities is at least one of sharing the data, replying to the data, indicating a like to the data, indicating a dislike to the data, following the data, voting for the data, and tagging the data.

19. The computer system of claim 12, wherein the electronic media content is at least one of a social networking website, online blogs, online forums, media sharing websites, and information website.

20. The computer system of claim 12, wherein the data is at least one of a text message, a picture, a Uniform Resource Locator (URL) and an automated message drawn in response from an activity.

21. The computer system of claim 12, wherein the data includes feedback of at least one of a product and a service comprising at least one of positive information, negative information and a neutral information.

22. The computer system of claim 12, wherein the data is at least one of:
a. manually posted by the one or more users utilizing an input system; and
b. automatically posted by an automated communication system in response to the actions performed by the one or more users.

23. A non-transitory, computer-readable storage medium storing computer-executable program instructions to implement:
a. tracking one or more activities associated with a data present in an electronic media content;
b. determining a social influence value of the data based on the one or more activities; and
c. electronically rewarding one or more users associated with the data based on the social influence value.

24. The medium of claim 23, further comprising instructions to implement:
a. analyzing the one or more activities to identify one or more types of activities in the one or more activities; and
b. associating a predefined values with each type of activity of the one or more types of activities.

25. The medium of claim 24, further comprising instructions to implement:
a. identifying count of occurrence associated with each type of activity of the one or more types of activities; and
b. calculating the social influence value of the data based on the predefined values associated with the each types of activity and the count of occurrence associated with the each type of activity.

26. The medium of claim 25, further comprising instructions to implement:
calculating the social influence value based on a factor multiplier associated with the data.

27. The medium of claim 23, wherein the program instruction to track the one or more activities is performed for a predefined timeframe.

28. The medium of claim 23, wherein the electronically rewarding is performed if the social influence value is greater than a threshold value.

29. The medium of claim 23, wherein the one or more activities is at least one of sharing the data, replying to the data, indicating a like to the data, indicating a dislike to the data, following the data, voting for the data, and tagging the data.

30. The medium of claim 23, wherein the electronic media content is at least one of a social networking website, online blogs, online forums, media sharing websites, and information website.

31. The medium of claim 23, wherein the data is at least one of a text message, a picture, a Uniform Resource Locator (URL) and an automated message drawn in response from an activity.

32. The medium of claim 23, wherein the data includes feedback of at least one of a product and a service comprising at least one of positive information, negative information and a neutral information.

33. The medium of claim 23, wherein the data is at least one of:
a. manually posted by the one or more users utilizing an input system; and
b. automatically posted by an automated communication system in response to the activities performed by the one or more users.
